(19) United States
(12) Patent Application Publication
(10) Pub. No.: US 2025/0046828 A1
(43) Pub. Date: Feb. 6, 2025

(54) ION EXCHANGE-FUNCTIONALIZED CATALYST SUPPORTS

(71) Applicant: 1s1 Energy, Inc., Portola Valley, CA (US)

(72) Inventors: Sukanta Bhattacharyya, Belmont, CA (US); Daniel Sobek, Portola Valley, CA (US)

(21) Appl. No.: 18/717,381

(22) PCT Filed: Oct. 7, 2022
(86) PCT No.: PCT/US2022/046105

§ 371 Date: Jun. 6, 2024

Related U.S. Application Data
(60) Provisional application No. 63/320,148, filed on Mar. 15, 2022.
(60) Provisional application No. 63/286,988, filed on Dec. 7, 2021.

(51) Int. Cl. H01M 4/92; C25B 11/067; H01M 4/88

(52) U.S. Cl. CPC H01M 4/925; C25B 11/067; H01M 4/8817

(57) ABSTRACT

An ion exchange-functionalized catalyst support includes a ceramic catalyst support and an ion exchange group at a surface of the ceramic catalyst support. The ceramic catalyst support includes at least one of a covalent nitride, a covalent metal boride, and a covalent carbide.

### RELATED APPLICATIONS

The present application claims priority to U.S. Provisional Patent Application No. 63/286,988, filed Dec. 7, 2021, and U.S. Provisional Patent Application No. 63/320,148, filed Mar. 15, 2022, which are hereby incorporated by reference in their entireties.

### BACKGROUND INFORMATION

In electrochemical cells, such as hydrogen fuel cells and water electrolysis systems, proton exchange membranes (PEMs) are used to selectively transport protons. Proton exchange membranes (PEMs) are semipermeable membranes that transport protons (H⁺) while being impermeable to gases. PEMs are generally composed of a porous framework with highly acidic functional groups. For example, polyfluorosulfonic acid-based PEMs contain a polytetrafluoroethylene (PTFE) porous framework with sulfonic acid groups. The easily dissociable sulfonic acid groups serve as proton transport agents in the membrane. In hydrogen fuel cells, hydrogen gas (H₂) separates at the anode into protons (H⁺) and electrons. The protons pass through a PEM and combine with oxygen gas (O₂) at a cathode to produce water while the electrons flow through an external circuit to produce electricity. In water electrolysis systems, electricity splits water at the anode into oxygen gas (O₂) and protons (H⁺). The protons pass through the PEM and combine with electrons at the cathode to produce hydrogen gas (H₂).

A membrane electrode assembly (MEA) may include a PEM positioned between a first catalyst layer and a second catalyst layer. The catalyst layers are electrically conductive electrodes (anode and cathode) with embedded electrochemical catalysts such as metals, metal alloys, or metal oxides. The catalysts may be bound to a catalyst solid support, which generally are an electrically conductive, high surface-area carbon (e.g., graphite or graphene). The electrochemical catalysts reduce the activation energy needed to carry out electrochemical reactions at the electrodes, such as the oxygen evolution reaction (OER) and hydrogen evolution reaction (HER) in water electrolysis applications and the hydrogen oxidation reaction (HOR) and oxygen reduction reaction (ORR) in fuel cell applications.

In some applications, the catalyst layer includes a supported catalyst mixed with an ion-conducting polymer (e.g., an ionomer). The ionomer binds the catalysts within the electrode, binds the catalyst layer on the PEM, and provides a pathway for cations (e.g., protons), thereby improving cation conductivity. In some MEAs, the catalyst layers are formed separately from the PEM and layered on the PEM in the MEA stack. In other MEAs, the catalyst layers are coated on the PEM to form catalyst-coated membranes (CCMs).

Tight binding of catalyst particles with catalyst solid supports may diminish performance of the catalyst and conductivity of cations, while loose binding of catalyst particles with catalyst solid supports may result in undesired catalyst loss, thereby decreasing catalyst turnovers. Moreover, catalyst particles may separate from the catalyst layer and enter the PEM and damage the PEM. Accordingly, catalyst binding to catalyst solid supports should be neither too tight nor too loose to provide smooth and efficient participation in catalytic cycles.

### SUMMARY

The following description presents a simplified summary of one or more aspects of the apparatuses, compositions, and/or methods described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the apparatuses, compositions, and/or methods described herein in a simplified form as a prelude to the more detailed description that is presented below.

In some illustrative examples, an ion exchange-functionalized catalyst support comprises a ceramic catalyst support comprising a binary covalent nitride, a binary covalent metal boride, a binary covalent carbide; a ternary covalent nitride-boride, a ternary covalent nitride-carbide, or a ternary covalent boride-carbide; and an ion exchange group at a surface of the ceramic catalyst support.

In some illustrative examples, a catalyst layer comprises: an ion exchange-functionalized catalyst support comprising a ceramic catalyst support comprising a covalent nitride, a covalent metal boride, or a covalent carbide; and an ion exchange group at a surface of the ceramic catalyst support; and a catalyst particle supported on the ion exchange-functionalized catalyst support.

In some illustrative examples, a method of making an ion exchange-functionalized catalyst support comprises functionalizing a surface of a ceramic catalyst support with an ion exchange group, the ceramic catalyst support comprising a covalent nitride, a covalent metal boride, or a covalent carbide.

### BRIEF DESCRIPTION OF THE DRAWINGS

In order that the concepts described herein may be better understood, various embodiments will be described by way of example only, with reference to the drawings. The drawings illustrate various embodiments and are a part of the specification. The illustrated embodiments are merely examples and do not limit the scope of the disclosure. Throughout the drawings, identical or similar reference numbers designate identical or similar elements.

FIG. 1A shows an illustrative scheme for surface functionalization of a ceramic catalyst support using a fluoride reagent.

FIG. 1B shows another illustrative scheme for surface functionalization of a ceramic catalyst support using a fluoride reagent.

FIG. 2A shows an illustrative scheme for surface functionalization of a ceramic catalyst support using an acid reagent or an alcohol reagent.

FIG. 2B shows another illustrative scheme for surface functionalization of a ceramic catalyst support using an acid reagent or an alcohol reagent.

FIG. 3 shows an illustrative ion exchange-functionalized catalyst support comprising hexagonal boron-nitride formed by the scheme of FIG. 1A.

FIG. 4 shows the ion exchange-functionalized catalyst support of FIG. 3 in which platinum (Pt) catalyst particles are supported on the ion exchange-functionalized catalyst supports.

FIG. 5 shows an illustrative proton exchange membrane water electrolysis system incorporating ion exchange-functionalized catalyst supports.

FIG. 6 shows an illustrative proton exchange membrane fuel cell incorporating ion exchange-functionalized catalyst supports.

### DETAILED DESCRIPTION

Ion exchange-functionalized catalyst supports, apparatuses using ion exchange-functionalized catalyst supports, and methods of making ion exchange-functionalized catalyst supports are described herein. For example, an ion exchange-functionalized catalyst support may include a ceramic catalyst support and an ion exchange group at a surface of the ceramic catalyst support. The ceramic catalyst support may include a covalent ceramic material, such as a covalent nitride, a covalent metal boride, a covalent carbide, and/or a composite of these ceramic materials. The covalent ceramic material is characterized by covalent bonds and includes a multivalent element such as boron, silicon, and/or aluminum.

The ion exchange group includes a multivalent element at a surface of the ceramic catalyst support and a pendant surface group that is covalently bonded to the multivalent element. The multivalent element thus has an expanded valence state, which imparts a negative formal charge on the multivalent atom and makes the ion exchange group intrinsically ionic and acidic when the counter-cation is a proton. Thus, ion exchange may occur at the negatively charged multivalent element. Accordingly, a surface of the ceramic catalyst support is functionalized with an ion exchange group.

The ceramic catalyst support may also bind catalyst particles. For example, covalent nitrides have a crystalline structure formed by covalent bonds between nitrogen and boron, silicon, aluminum, and/or carbon. Nitrogen atoms at the surface of a covalent nitride have a lone pair of electrons that attract and bind catalyst particles, such as platinum, platinum group metals, and non-platinum group metals. Similarly, covalent metal borides have a structure formed by covalent bonds between boron and less electronegative metal atoms while metal carbides have a structure formed by covalent bonds between carbon and less electronegative metal atoms. The covalent pi-bonds in metal borides and metal carbides also bind catalyst particles. Catalyst particles generally have affinity to oxygen and/or nitrogen ligands of the covalent ceramic material, thereby maintaining the catalyst particle in proximity to the ceramic catalyst support and thereby reducing or preventing catalyst migration.

The ion exchange-functionalized catalyst supports described herein have both metal-binding properties, through the ceramic catalyst support materials, as well as ionomer properties, through the ion exchange groups, while maintaining electrical conductivity. When used in a catalyst layer, catalyst-coated membrane (CCM), or membrane electrode assembly (MEA), the ion exchange-functionalized catalyst supports described herein increase ion conductivity in electrochemical cell systems and increase contact and binding between catalyst support, catalyst particles, ionomer, and electrodes, thereby decreasing loss of catalyst particles. Moreover, ion exchange-functionalization of surfaces of the ceramic catalyst support materials is believed to increase the active surface area of the catalyst support and provide additional facilities for proton transport.

As used herein, a “catalyst particle” refers to a particle in “black” or pure form (e.g., exclusive of any catalyst support to which the catalyst particle may be bound and exclusive of any catalyst additives) that increases the rate of a reaction without modifying the overall standard Gibbs free energy change in the reaction. A catalyst particle may be an individual molecule or may be a group of molecules.

As used herein, an “electrocatalyst particle” or “electrochemical catalyst particle” refers to a catalyst particle that reduces the activation energy needed to carry out electrochemical reactions and/or increases the rate of electrochemical reactions, such as the oxygen evolution reaction (OER), hydrogen evolution reaction (HER), hydrogen oxidation reaction (HOR), and/or oxygen reduction reaction (ORR). Suitable electrocatalysts may include, without limitation, metals such as platinum group metals (PGMs) (e.g., platinum, palladium, iridium, ruthenium, osmium, and rhodium), transition metals (e.g., silver, gold, cobalt, copper, iron, nickel, rhenium, and mercury), and post-transition metals (e.g., tin), metal alloys (e.g., PGM alloys with transition metals and platinum-ruthenium based alloys), and/or metal oxides (e.g., iridium ruthenium oxide, iridium oxide, magnesium oxide, and cerium (IV) oxide).

As used herein, a “catalyst support” refers to a substance, exclusive of a catalyst particle, that may be used to support catalyst particles (e.g., a substance or material to which catalyst particles may be bound or on which catalyst particles may be supported). Examples of catalyst supports include, without limitation, carbon (e.g., graphite, carbon nano-tubes, and/or graphene) and/or the ion exchange-functionalized catalyst supports described herein.

As used herein, a “catalyst” refers to a catalyst particle and/or a catalyst particle together with a catalyst support on which the catalyst particle is supported. A catalyst may also include catalyst additives.

As used herein, an “electrocatalyst” or “electrochemical catalyst” refers to an electrocatalyst particle in “black” or pure form as well as an electrocatalyst particle together with a catalyst support on which the electrocatalyst particle is supported. An electrocatalyst may also include catalyst additives.

As used herein, “metal” includes alkali metals, alkaline earth metals, transition metals, post-transition metals, and metalloids.

As used herein, an “ionomer” refers to a polymer composed of macromolecules in which a small but significant proportion (e.g., about 15 mol % or less) of the constitutional units has ionic and/or ionizable groups (e.g., a sulfonic acid group, a carboxylic acid group, a phosphoric acid group, a tetravalent boron-based acid group, etc.).

As used herein, “multivalent” means that an atom is not restricted to a specific number of valence bonds but may have multiple different valence states each with a different number of valence bonds. Thus, the multivalent metal atom may “expand its valence state,” such as by one to three to form a tetravalent, pentavalent, or hexavalent structure with a negative one (−1), negative two (−2), or negative three (−3) formal charge. For example, boron has three valence electrons and has a ground state electron configuration of 1s²2s²2p¹. Boron generally forms trivalent neutral compounds in which boron has three covalent bonds. Thus, the boron atom is sp² hybridized with an empty p-orbital, which makes trivalent boron compounds electron-deficient. However, boron is multivalent due to the empty p-orbital, so boron can also form negatively charged tetravalent compounds with four covalent bonds. Electrically neutral aluminum also has three valence electrons and thus generally forms three covalent bonds. However, aluminum can also expand its valence state by one to form a tetravalent ion with a negative formal charge. Electrically neutral silicon has four valence electrons and thus generally forms four covalent bonds. However, silicon can also expand its valence state by one or two to form a pentavalent or hexavalent ion with a negative one (−1) or negative two (−2) formal charge, respectively.

As used herein, “ceramic” means an inorganic, non-metallic, or metalloid solid compound formed by two or more elements. The main classes of ceramics include oxides, nitrides, carbides, and borides, although other compounds may be ceramic. Ceramic materials may also include composite ceramics. Typically, ceramic materials are held together by covalent and/or ionic interatomic bonding forces, although ceramic materials may also have some metallic and/or van der Waals interatomic bonding forces. The microstructure of ceramics can be entirely glassy, entirely crystalline, or a combination of crystalline and glassy. The crystal structures of ceramics are many and varied, which results in a very wide range of physical and chemical properties. The composition of ceramic materials may be stoichiometric or non-stoichiometric, and the general formulas given for ceramic materials herein are approximations and are not intended to be limiting. Ceramics may include dopants, defects, and/or impurities (e.g., elemental or molecular impurities), such as to control or adjust various physical, chemical, and electrical properties of the ceramic material (e.g., hydrophobicity, hydrophilicity, electrical conductivity, thermal resistivity, melting point, etc.) for use in a particular application. An example of an impurity is oxygen, which in some examples may constitute up to about five atomic percent of a ceramic material.

As used herein, a “composite” means a material having a combination of two or more distinct materials, each of which retains its own distinctive properties, but which has properties that the constituent materials do not have acting alone. Ceramic composites include materials having a combination of multiple different ceramic materials as well as materials having a combination of ceramic materials and non-ceramic materials (e.g., metal, polymer, carbon).

As used herein, a material is “covalent” when it is characterized by predominantly covalent interatomic bonding forces. Generally, ceramics formed with elements of similar electronegativity, such as boron, aluminum, silicon, carbon, nitrogen, and/or oxygen, form covalent ceramics. Some metal borides may also form covalent ceramics. On the other hand, the degree of ionic bonding in a ceramic material increases as the difference in electronegativity increases between bonding atoms of the ceramic material. Some ceramics have mixed bonding, meaning they have multiple different types of interatomic bonding (e.g., ionic and covalent), or that interatomic bonds are not easily characterized as fully ionic, fully covalent, or fully metallic. As used herein, a material is covalent when most (or all) of the interatomic bonding is more covalent than ionic (or metallic). Examples of covalent ceramic materials that may be used in the ion exchange-functionalized catalyst supports described herein include covalent nitrides (e.g., silicon nitride, boron nitride, aluminum nitride), covalent borides (e.g., niobium boride, tantalum boride), and covalent carbides (e.g., silicon carbide, boron carbide), and ceramic composites including covalent ceramic materials.

Illustrative ion exchange-functionalized catalyst supports will now be described. An ion exchange-functionalized catalyst support includes a ceramic catalyst support and an ion exchange group at a surface of the ceramic catalyst support.

The ceramic catalyst support includes a covalent ceramic material. In some examples, the covalent ceramic material is a covalent nitride, a covalent metal boride, a covalent carbide, and/or a composite of two or more covalent ceramic materials, including covalent nitrides, covalent metal borides, and/or covalent carbides.

A nitride is a ceramic compound in which nitrogen is combined with an element of similar or lower electronegativity. Nitrides can be classified based on their bonding as ionic, interstitial, or covalent. Covalent nitrides have a structure formed by predominantly covalent bonds. The nitrogen atoms of covalent ceramic nitrides have a lone pair of electrons that may attract and bind catalyst particles. In some examples, the ceramic material is a covalent nitride. In some examples, the covalent nitride includes nitrogen combined with one or more multivalent elements, including but not limited to boron, silicon, and/or aluminum. As will be explained below in more detail, a multivalent element may covalently bond to a pendant surface group and thereby form an ion exchange group while the nitrogen atoms bind catalyst particles.

In some examples, the covalent nitride is a binary nitride comprising boron nitride (BN), silicon nitride (Si₃N₄), or aluminum nitride (AlN).

Boron nitride is a compound of boron and nitrogen with the chemical formula BN. Boron nitride exists in various polymorphic forms, including hexagonal boron nitride (h-BN), cubic boron nitride (c-BN), wurtzite boron nitride (w-BN), and amorphous boron nitride (a-BN), among others. Any form of boron nitride may be used as the covalent nitride that constitutes the covalent ceramic material of the ceramic catalyst support.

In some examples, the covalent nitride includes hexagonal boron nitride. Hexagonal boron nitride has structural similarities with graphite. Hexagonal boron nitride has a layered structure in which each layer is formed of planar, six-membered rings of alternating boron and nitrogen atoms bonded together with boron-nitrogen pi-bonds, similar to the carbon-carbon pi-bonds in graphite. The mostly sp² hybridized nitrogen atoms in hexagonal boron nitride have a lone pair of electrons, which offers a unique electronic binding handle for catalyst particles at the surface of the covalent nitride.

Hexagonal boron nitride may have multiple layers arranged so that a boron atom in one layer is located over a nitrogen atom in the adjacent layer. Adjacent layers are held together by weak van der Waals forces. However, unlike graphite, the boron-nitrogen bonds in hexagonal boron nitride are dipolar due to the electronegativity differences between boron and nitrogen, thus generating partial negative charges on the more electronegative nitrogen atoms while the less electronegative boron atoms have partial positive charges. While graphite is a strong conductor of electricity, hexagonal boron nitride is electrically non-conducting. On the other hand, while graphite is unable to transport protons, hexagonal boron nitride has ion transport abilities due to the partial charges on the nitrogen and/or boron atoms.

Silicon nitride is a compound of silicon and nitrogen with various different compositions. In some examples, silicon nitride is Si₃N₄, which is generally thermodynamically and chemically stable. Si₃N₄ exists in various forms, including trigonal (α-Si₃N₄), hexagonal (β-Si₃N₄), cubic (γ-Si₃N₄), and amorphous. Any composition and form of silicon nitride may be used as the covalent nitride that constitutes the covalent ceramic material of the ceramic catalyst support.

Aluminum nitride is a compound of aluminum and nitrogen with the general formula AlN. Aluminum nitride exists in various forms, including a hexagonal wurtzite structure and a cubic zincblende phase. Any composition and form of aluminum nitride may be used as the covalent nitride that constitutes the covalent ceramic material of the ceramic catalyst support.

In some examples, the covalent nitride includes nitrogen combined with two or more elements of boron, silicon, and carbon. In some examples, the covalent nitride is a ternary nitride comprising boron carbon nitride, silicon carbon nitride, or silicon boron nitride, each of which includes at least one multivalent element (e.g., boron or silicon).

Boron carbon nitride (abbreviated B—C—N) is a compound of boron, carbon, and nitrogen with the general formula BₓC_{y}N_{z} where x, y, and z may be any combination of numbers (integer or real) within the ternary B—C—N system. For example, boron carbon nitride may include B₁C₁N₁, BC₄N, BC₂N, B₁₃CN, carbon-doped hexagonal boron nitride (h-BCN), or any other composition within the B—C—N ternary system. In B—C—N, boron, carbon, and nitrogen covalently bond, making B—C—N thermally and mechanically robust. The composition of B—C—N(e.g., the values of x, y, and z) may be tuned to obtain a B—C—N composition with desired properties for a particular application.

Silicon carbon nitride (abbreviated Si—C—N) is a compound of silicon, carbon, and nitrogen with the general formula SiₓC_{y}N_{z} where x, y, and z may be any combination of numbers (integer or real) within the ternary Si—C—N system. In Si—C—N, silicon, carbon, and nitrogen covalently bond, making Si—C—N thermally and mechanically robust. The composition of Si—C—N(e.g., the values of x, y, and z) may be tuned to obtain a Si—C—N composition with desired properties for a particular application.

Silicon boron nitride (abbreviated Si—B—N) is a compound of silicon, boron, and nitrogen with the general formula SiₓB_{y}N_{z} where x, y, and z may be any combination of numbers (integer or real) within the ternary Si—B—N system. In Si—B—N, silicon, boron, and nitrogen covalently bond, making Si—B—N thermally and mechanically robust. The composition of Si—B—N (e.g., the values of x, y, and z) may be tuned to obtain a Si—B—N composition with desired properties for a particular application.

In some examples, the ceramic catalyst support includes a covalent metal boride. A metal boride is a ceramic compound in which boron is combined with a metal of similar or lower electronegativity by predominantly covalent bonds. The metal atoms of the metal boride attract and bind catalyst particles while the boron atoms at the surface of the ceramic catalyst support covalently bond with pendant surface groups to form ion exchange groups. The pi-type covalent bonds in metal borides are electron donating and help binding with metallic catalyst particles.

In some examples, the metal (M) of the metal boride is one or more metals in Group 2, Group 4, Group 5, Group 6, Group 8, Group 13, and/or Group 14 of the periodic table. In some examples, the metal of the metal boride is a transition metal. In some examples, the metal boride includes a transition metal selected from Group 4, Group 5, and/or Group 6. In some examples, the metal boride is a monoboride (TMB) or a diboride (TMB₂) formed with a transition metal (TM). In some examples, the transition metal (TM) is selected from Group 4, Group 5, or Group 6. In some examples, the metal of the metal boride comprises magnesium (Mg), titanium (Ti), zirconium (Zr), hafnium (Hf), vanadium (V), niobium (Nb), tantalum (Ta), chromium (Cr), iron (Fe), aluminum (AI), silicon (Si), and/or any combination of the foregoing.

In some examples, the covalent metal boride is a binary metal boride. Binary metal borides are generally characterized by short covalent bonds between boron (B) and a metal (M), which are believed to impart hardness and thermal and mechanical stability to the material. The stoichiometry of binary metal borides ranges from compounds with low boron content, such as M₅B, to compounds rich in boron, such as MB₆₆ or MB₉₉. A binary metal boride may have any suitable composition, and may be boron rich (e.g., having a boron:metal ratio of 4:1 or more) or metal rich (e.g., having a boron:metal ratio less than 4:1). Suitable examples of metal borides that may be used as the ceramic catalyst support include, without limitation, niobium boride (e.g., NbB, NbB₂), tantalum boride (e.g., TaB, TaB₂, Ta₅B₆, Ta₃B₄), titanium boride (e.g., TiB₂), zirconium boride (e.g., ZrB₂, ZrB₁₂), hafnium boride (e.g., HfB₂), vanadium boride (e.g., VB, VB₂), aluminum boride (e.g., AlB₂, AlB₁₂), magnesium boride (e.g., MgB₂, MgB₄, MgB₆, MgB₇, MgB₁₂, MgB₂₀, Mg₂B₂₅), chromium boride (e.g., CrB₂), iron boride (e.g., FeB, FezB, FeB₄), and silicon boride (e.g., SiB₃, SiB₆).

Metal borides comprising a metal selected from Group 4, such as vanadium boride (VB), vanadium diboride (VB₂), niobium boride (NbB), niobium diboride (NbB₂), triniobium diboride (Nb₃B₂), tantalum boride (TaB), and tantalum diboride (TaB₂), have distinct, stable structures.

In some examples, the covalent metal boride comprises a niobium boride. Niobium borides are binary compounds comprising niobium and boron and exist in a number of structural and stoichiometric variations. The stoichiometric and non-stoichiometric variations of niobium borides are easily synthesizable to scale. In all types of niobium boride compositions, niobium is covalently bonded with boron through niobium-boron multiple bonds wherein boron is in its trivalent state. Both niobium boride (NbB) and niobium diboride (NbB₂) have covalent bonds. Niobium diboride (NbB₂) has covalent planar hexagonal sheet-like structural layers as in graphite. Niobium borides are highly stable ceramic materials with ultra high thermal and electrical conductivity and excellent chemical stability against oxidation. Any suitable composition and structure of niobium boride may be used as the covalent metal boride of the ceramic catalyst support.

Niobium borides offer unique advantages as catalyst supports for electrocatalyst particles. Niobium borides increase the throughput, performance, and stability of CCMs and MEAs. For example, niobium boride catalyst supports provide reversible anchoring of catalyst particles, enhanced catalyst particle stability, and increased catalyst particle turnover. Design of efficient solid catalyst supports offering reversible anchoring of catalyst particles improves catalyst performance and minimizes catalyst particle loss as compared with conventional catalyst supports. Niobium boride catalyst supports also offer cooperative and synergistic effects for better catalytic activities, catalytic cycles, and catalyst turnover for platinum group metal (PGM) catalyst particles. Niobium boride catalyst supports offer high efficiency with low-loading (e.g., <10 wt. %) of platinum (Pt) and PGM catalyst particles.

Niobium boride catalyst supports also provide superb electrical conductivity exceeding what traditional carbon-based catalyst solid supports provide. In all types of niobium boride compositions, niobium is covalently bonded with boron through niobium-boron multiple bonds wherein boron is in its trivalent state. These covalent niobium boride frameworks provide the mechanisms for ultra high electrical conductivity of niobium borides along with their unique anchoring capabilities with electrocatalyst particles (e.g., PGMs).

Niobium boride catalyst supports also increase the contact surfaces between/among various layers and compositions within electrochemical cells (e.g., catalyst particles, ionomer, catalyst layer, PEM, CCM, gas diffusion layer (GDL), MEA, etc.). Thus, niobium borides enhance the binding of the various components as compared with conventional catalyst supports. The enhanced binding of the components, along with fine-tuning the hydrophobic and hydrophilic balances in PEMs, catalyst layers, and CCMs, improves the components' coordinated performance. For example, niobium boride catalyst supports ensure coordinated interactions among catalyst particles, electrode, and ionomer in the catalyst layer; between a catalyst layer and a PEM in a CCM; and between a CCM and a GDL in an MEA.

Niobium boride catalyst supports are thermally, mechanically, and chemically durable under operating conditions of electrochemical cells. As mentioned, niobium borides enhance the binding of the various components of electrochemical cells as compared with conventional catalyst supports. Furthermore, niobium borides have excellent stability against oxidation and redox stress, which is an important parameter in electrochemical reactions.

In some examples, the metal boride is electrically conducting. Metal borides formed with a Group 4 metal are electrically conducting, as are silicon borides and niobium borides. Other metal borides may be electrically conducting.

In some examples, the ceramic material of the ceramic catalyst support is a covalent carbide. Carbides are compounds composed of carbon and a less electronegative element or compound, usually a metal or a metal oxide. Like nitrides, carbides may be classified as ionic, interstitial, or covalent. Covalent carbides have a structure formed by predominantly covalent bonds. Covalent carbides are generally formed with boron and/or silicon. In some examples, the covalent carbide is a binary carbide, such as silicon carbide or boron carbide.

Silicon carbide is formed of carbon and silicon and has the general formula SiC. Silicon carbide exists in many different crystalline structures (polytopes), including but not limited to alpha silicon carbide (α-SiC), beta modification silicon carbide ((β)3C—SiC), 4H—SiC, and (α)6H—SiC, as well as amorphous forms. Any composition and form of silicon carbide may be used as the ceramic material of the ceramic catalyst support. In some examples, the ceramic material is formed of hexagonal silicon carbide.

Boron carbide is formed of carbon and boron and may have various different compositions, such as B₄C, B₁₂C₃, and BC₃. Boron carbide has a complex crystal structure typical of icosahedron-based borides. Any composition and form of boron carbide may be used as the ceramic material of the ceramic catalyst support.

In some examples, the ceramic material is a ceramic composite formed from a combination of one or more covalent nitrides, covalent metal borides, and/or covalent carbides described herein. The composite material includes at least one multivalent element, such as aluminum, boron, and/or silicon. For example, the ceramic material may be a nitride composite, a boride-nitride composite, a carbide-nitride composite, or a carbide-boride composite. In some examples, the ceramic composite material may also include, in addition to a covalent ceramic material, a non-covalent ceramic material (e.g., an ionic or interstitial nitride, boride, or carbide) and/or a non-ceramic material such as a metal, a polymer, and/or an electrically conducting carbon fiber and/or carbon powder such as graphite, graphene, and carbon nanotubes.

A nitride composite is formed of two or more covalent nitrides (binary nitrides and/or ternary nitrides). Illustrative examples of nitride composites include, without limitation, boron nitride-silicon nitride (BN—SiN), boron nitride-aluminum nitride (BN—AlN), silicon nitride-aluminum nitride (SiN—AlN), and boron nitride-silicon nitride-aluminum nitride (BN—SiN—AlN).

A boride-nitride composite is formed of one or more covalent metal borides and one or more covalent nitrides (e.g., binary nitrides and/or ternary nitrides). Illustrative examples of boride-nitride composites include, without limitation, titanium diboride-aluminum nitride (TiB₂—AlN), boron nitride-niobium boride (BN—NbB), boron nitride-niobium diboride (BN—NbB₂), boron nitride-tantalum boride (BN—TaB), and zirconium diboride-aluminum nitride (ZrB₂—AlN).

A carbide-nitride composite is formed of one or more covalent carbides and one or more covalent nitrides (binary nitrides and/or ternary nitrides). Illustrative examples of carbide-nitride composites include, without limitation, hexagonal boron nitride-boron carbide (h-BN—BC), hexagonal boron nitride-silicon carbide (h-BN—SiC), silicon nitride-silicon carbide (Si₃N₄—SiC), and silicon nitride-boron carbide (SiN—BC).

A boride-carbide composite is formed of one or more covalent metal borides and one or more covalent carbides. Illustrative examples of carbide-boride composites include, without limitation, zirconium diboride-silicon carbide (ZrB₂—SiC), niobium diboride-silicon carbide (NbB₂—SiC), and zirconium diboride-boron carbide (ZrB₂—B₄C).

The ion exchange group of the ion exchange-functionalized catalyst support includes a multivalent element (e.g., boron, silicon, or aluminum) at a surface of the ceramic catalyst support and a pendant surface group covalently bonded to the multivalent atom. Thus, the multivalent atom has a negative formal charge and is intrinsically ionic and acidic and enables ion exchange. The pendant surface group may be a derivative of a fluoride reagent (e.g., hydrogen fluoride, a metal fluoride, or a tetraalkylammonium fluoride), an acid reagent (e.g., sulfuric acid, an alkyl- or aryl-sulfonic acid, phosphoric acid, or its partial esters, a phosphonic acid or its partial esters, a carboxylic acid, or a salt of an acid), or an alcohol reagent (e.g., a poly- or per-fluorinated ethanol or phenol) that covalently bonds to the multivalent atom. For example, the pendant surface group may be a fluorine atom (derivative of a fluoride reagent) or an acid ester (a derivative of an acid reagent) along with the counter-cations. Illustrative examples of functionalizing a surface of the ceramic catalyst support with the ion exchange group will now be described.

The ceramic catalyst support (described above) may be surface-functionalizing using a nucleophilic reagent to obtain an ion exchange group at a surface of the ceramic catalyst support. The nucleophilic reagent covalently bonds with a multivalent atom at a surface of the ceramic catalyst support. In some examples, the nucleophilic reagent is a fluoride reagent (e.g., hydrogen fluoride, a metal fluoride, and/or a tetraalkylammonium fluoride). In other examples, the nucleophilic reagent is an acid reagent. The surfaces of the ceramic catalyst support may be modified in a controlled way to obtain a catalyst support having properties tuned for the intended application of the catalyst support. The negative charge on multivalent element of the ion exchange group is balanced by a cation from the nucleophilic reagent, such as the proton from hydrogen fluoride or an acid, the metal cation from the metal fluoride, or the tetraalkylammonium cation. The ion exchange-functionalized catalyst supports have both ionomer properties, through the ion exchange groups, as well as metal-binding properties through the ceramic material (e.g., through nitrogen donor atoms), making the ion exchange-functionalized catalyst supports highly suitable for electrochemical reactions. The counter-cations may be chosen differently to tune up hydrophilic lipophilic balance.

Various illustrative reaction schemes for synthesizing ion exchange-functionalized catalyst supports will now be described. It will be understood that the following examples are merely illustrative and are not limiting.

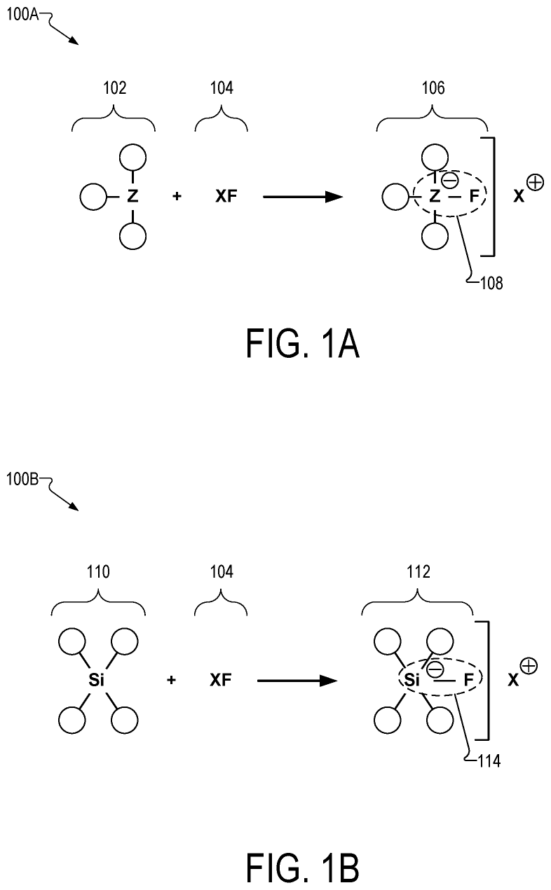

FIG. 1A shows an illustrative scheme 100A for surface functionalization of a ceramic catalyst support using a fluoride reagent. As shown, a ceramic catalyst support 102 is combined with a fluoride reagent 104 to produce an ion exchange-functionalized catalyst support 106. Ceramic catalyst support 102 includes a trivalent atom Z at a surface of ceramic catalyst support 102. Z is covalently bonded to three other atoms (e.g., nitrogen and/or carbon). In some examples, Z is boron or aluminum. Ceramic catalyst support 102 may be any boron- or aluminum-containing ceramic material described herein, such as a boron nitride, a metal boride, a boron carbide, an aluminum nitride, an aluminum boride, and/or a composite including any of the foregoing. Fluoride reagent 104 includes a group X bonded to a fluoride group (F⁻). In some examples, X is hydrogen (H), a metal (M), or tetraalkylammonium having general formula R₄N⁺. Metal (M) may be any suitable metal. In some examples, metal (M) is an alkali metal (e.g., lithium (Li), sodium (Na), potassium (K)), an alkaline earth metal (e.g., magnesium (Mg), calcium (Ca)), a transition metal, including but not limited to a metal in Group 4 (e.g., zirconium (Zr)), a platinum group metal (PGM), a non-PGM, a metal in Group 13 (e.g., boron (B), aluminum (AI), gallium (Ga), and indium (In)), and/or a metal in Group 14 (e.g., silicon (Si), germanium (Ge), and tin (Sn)). In some examples, metal (M) functions as a catalyst particle or a co-catalyst with another catalyst particle that may be supported on ceramic catalyst support 102. R is an alkyl or aryl group such as a methyl, ethyl, propyl, or butyl group.

In scheme 100A, the fluoride group of fluoride reagent 104 covalently bonds with Z of ceramic catalyst support 102, thereby forming an ion exchange group 108 that includes Z and the fluorine of fluoride reagent 104 as the pendant surface group. Z expands its valence state from three to four, becoming tetravalent with a negative formal charge that is counterbalanced by the cation (X⁺) from fluoride reagent 104 (e.g., a proton (H⁺), lithium (Li⁺), sodium (Na⁺), potassium (K⁺), other metal cation, or tetraalkylammonium). Thus, ion exchange-functionalized catalyst support 106 is intrinsically ionic and acidic and enables proton exchange at ion exchange group 108 (e.g., at atom Z).

FIG. 1B shows another illustrative scheme 100B for surface functionalization of a ceramic catalyst support using a fluoride reagent. Scheme 100B is similar to scheme 100A except that, in scheme 100B, a ceramic catalyst support 110 having a surface-bound tetravalent silicon atom (Si) is combined with fluoride reagent 104 to produce ion exchange-functionalized catalyst support 112. Ceramic catalyst support 110 may be any silicon-containing ceramic material described herein, such as a silicon nitride, a silicon carbon nitride, a silicon boron nitride, a silicon carbide, and/or a composite including any of the foregoing. Fluoride reagent 104 is as described above for scheme 100A.

In scheme 100B, the fluoride group of fluoride reagent 104 covalently bonds with the multivalent silicon of ceramic catalyst support 110, thereby forming an ion exchange group 114 that includes the silicon atom of ceramic catalyst support 110 and the fluorine of fluoride reagent 104 as the pendant surface group. Silicon expands its valence state from four to five, becoming pentavalent with a negative formal charge that is counterbalanced by the cation (X⁺) from fluoride reagent 104. Thus, ion exchange-functionalized catalyst support 112 is intrinsically ionic and acidic and enables proton exchange at ion exchange group 114 (e.g., at the silicon atom).

In the examples of schemes 100A and 100B, the nucleophilic reagent is fluoride reagent 104. In other examples, the nucleophilic reagent may be an acid reagent or an alcohol reagent. Illustrative schemes for surface functionalization of a ceramic catalyst support using acid reagents and/or alcohol reagents will now be described.

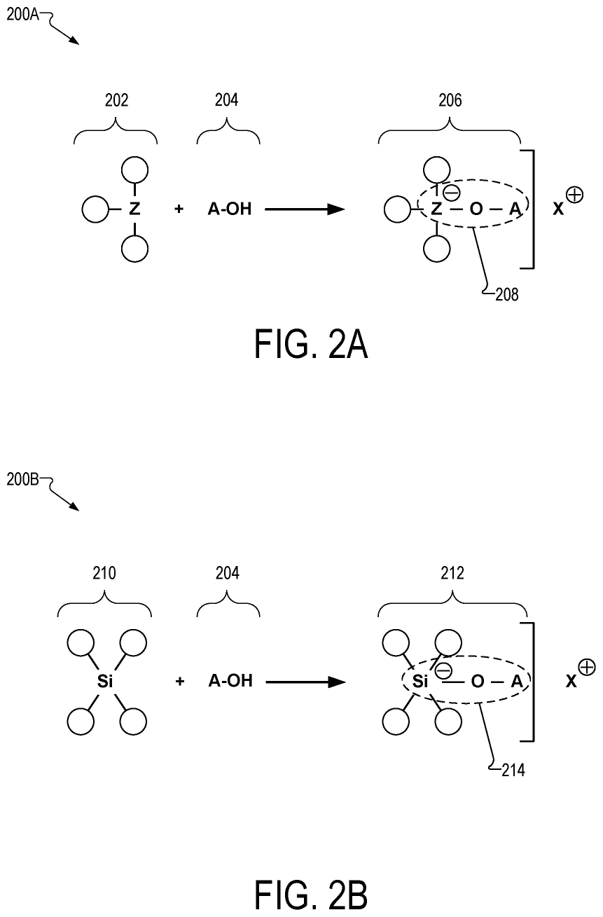

FIG. 2A shows an illustrative scheme 200A for surface functionalization of a ceramic catalyst support using an acid reagent and/or an alcohol reagent. As shown, a ceramic catalyst support 202 is combined with a reagent 204 to produce an ion exchange-functionalized catalyst support 206. Ceramic material 202 may be any boron- or aluminum-containing ceramic material described herein and may be the same as or similar to ceramic catalyst support 102 described above. Reagent 204 has the general formula A-OH where OH is a hydroxyl group and A represents a moiety of the reagent excluding the hydroxyl group. Reagent 204 may be an acid or an alcohol. For example, sulfonic acid reagent has the general formula (R—S(═O)₂—OH) where R is an alkyl or aryl group and may be unsubstituted or fully or partially substituted. Thus, A represents the alkyl sulfonyl group (R—S(═O)₂—). Reagent 204 may covalently bond with Z of ceramic catalyst support 202 by way of the oxygen atom after deprotonation. Illustrative examples of an acid reagent include, without limitation, sulfuric acid (H₂SO₄ or S(═O)₂(OH)₂), alkyl- and aryl-sulfonic acids (R—S(═O)₂—OH), phosphoric acid (H₃PO₄ or P(═O)(OH)₃) and its partial esters, phosphonic acids (R—P(═O)(OH)₂) and their partial esters, carboxylic acids (R—C(═O)(OH)), and salts of the foregoing acids (e.g., sulfate, hydrogen sulfate, sulfonate, phosphate, hydrogen phosphate, dihydrogen phosphate, phosphonate, hydrogen phosphonate), where R is an alkyl or aryl group and is unsubstituted or fully or partially substituted. Illustrative examples of an alcohol reagent include, without limitation, poly- and per-fluorinated alcohols (e.g., trifluoromethanol, pentafluoroethanol, tetrafluorophenol, pentafluorophenol). In some examples, scheme 200A uses multiple different reagents 204.

The salt or anion of acid reagent 204 covalently bonds with Z of ceramic catalyst support 202 by an ester linkage, thereby forming an ion exchange group 208 including Z of ceramic catalyst support 202 and the ester of acid reagent 204 as the pendant surface group. Z expands its valence state from three to four, becoming tetravalent with a negative formal charge that is counterbalanced by the proton (H⁺) from acid reagent 204. Due to ion exchange group 208, the ion exchange-functionalized catalyst support 206 is intrinsically ionic and acidic and enables proton exchange at the Z atom.

FIG. 2B shows another illustrative scheme 200B for surface functionalization of a ceramic catalyst support. Scheme 200B is similar to scheme 200A except that, in scheme 200B, a ceramic catalyst support 210 having a surface-bound tetravalent silicon atom (Si) is combined with reagent 204 to produce ion exchange-functionalized catalyst support 212. Ceramic catalyst support 210 may be any silicon-containing ceramic material described herein and may be the same as or similar to ceramic catalyst support 110 described above. The anion or salt of reagent 204 covalently bonds with the multivalent silicon of ceramic catalyst support 210, thereby forming an ion exchange group 214 that includes the silicon atom of ceramic catalyst support 210 and the ester of reagent 204 as the pendant surface group. Silicon expands its valence state from four to five, becoming pentavalent with a negative formal charge that is counterbalanced by the proton (H⁺) from reagent 204. Thus, ion exchange-functionalized catalyst support 212 is intrinsically ionic and acidic and enables proton exchange at ion exchange group 214 (e.g., at the silicon atom).

In the examples of FIG. 1A and FIG. 2A in which ceramic catalyst support 102 and 202 include a niobium boride, a titanium boride, and/or a zirconium boride, the functionalization reactions may not remain 100% selective to boron (Z) only because niobium, titanium, and/or zirconium at the surface may also partially react with the fluoride group of fluoride reagent 104 or with strong acid reagents 204, thereby generating formal negative charges onto the niobium, titanium, and/or zirconium atoms. In that event, an adjacent boron atom may not react with the fluoride reagent 104 or acid reagent 204 to become tetravalent. Nevertheless, a large percentage of the surface-bound boron atoms will react with the fluoride reagent 104 or acid reagent 204 to become tetravalent.

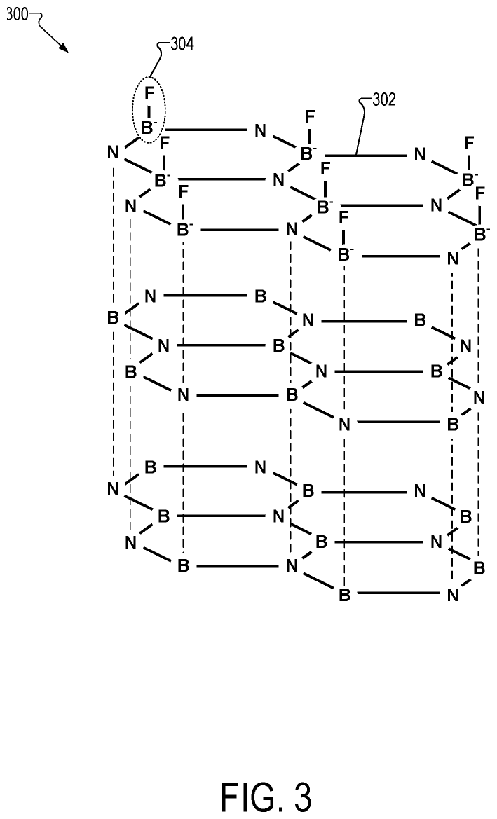

FIG. 3 shows an illustrative ion exchange-functionalized catalyst support 300 formed by scheme 100A. It will be recognized that FIG. 3 is merely illustrative of one possible configuration of an ion exchange-functionalized catalyst support, as other ceramic materials and other fluoride reagents, acid reagents, and/or alcohol reagents may be used as may serve a particular implementation. As shown, ion exchange-functionalized catalyst support 300 includes a ceramic catalyst support 302 comprising hexagonal boron nitride (h-BN) having multiple layers held together by van der Waals forces (indicated by vertical dashed lines) between opposing boron and nitrogen atoms. FIG. 3 shows only a portion of ion exchange-functionalized catalyst support 300, as each layer of the h-BN ceramic catalyst support 302 may have any number of hexagonal rings and the h-BN ceramic catalyst support 302 may have any number of layers. Moreover, the h-BN ceramic catalyst support 302 may have any suitable shape and form, such as a particle, a nanoparticle, a nanotube, a sheet, or a porous framework.

As shown, the upper surface of the h-BN ceramic catalyst support 302 is functionalized with ion exchange groups 304 each comprising a fluorine (F) atom and a boron (B) atom of the h-BN ceramic catalyst support 302 covalently bonded together. By bonding with a fluorine atom, the boron atoms are tetravalent and have a negative formal charge. As a result, the functionalized surface of ion exchange-functionalized catalyst support 300 is intrinsically ionic and enables cation exchange at the boron atoms. While FIG. 3 shows that only the upper surface of ion exchange-functionalized catalyst support 300 is functionalized with ion exchange groups 304, other surfaces of h-BN ceramic catalyst support 302 may be functionalized with ion exchange groups 304. Moreover, while FIG. 3 shows that all surface boron atoms of the upper surface are bonded to a fluorine atom, the degree of surface functionalization may be modified as desired by using the fluoride reagent as the limiting reagent.

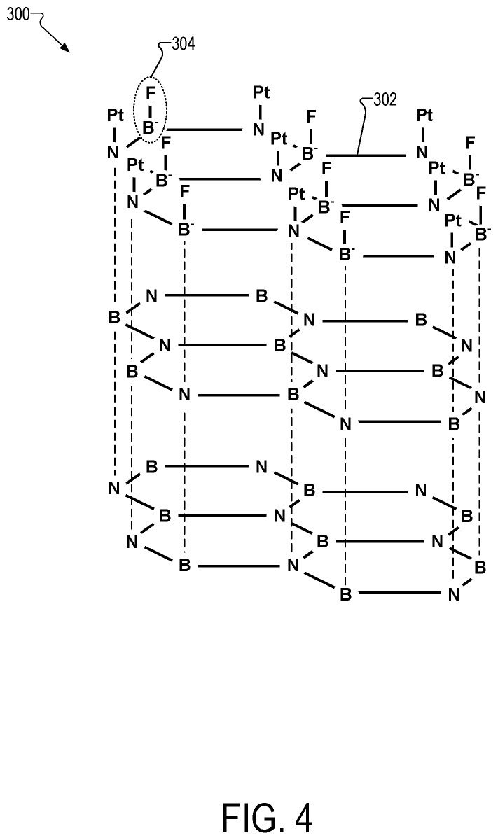

Ion exchange-functionalized catalyst support 300 may be used as a catalyst support to bind catalyst particles. The tetravalent nitrogen atoms have a lone pair of electrons that attract and bind catalyst particles. FIG. 4 shows ion exchange-functionalized catalyst support 300 in which platinum (Pt) catalyst particles are bound to the nitrogen atoms at the upper surface of h-BN ceramic catalyst support 302. While FIG. 4 shows individual platinum atoms bonded to nitrogen of the h-BN ceramic catalyst support 302, a catalyst particle may include a bulk catalyst particle having multiple platinum atoms. While FIG. 4 shows that only the upper surface of ion exchange-functionalized catalyst support 300 supports catalyst particles, other surfaces of h-BN ceramic catalyst support 302 may support catalyst particles. Moreover, while FIG. 3 shows that all surface nitrogen atoms of the upper surface bind catalyst particles, the degree of catalyst binding may be modified as desired. It will also be recognized that other catalyst particles may be used as may serve a particular implementation.

The surface modification of trivalent boron or aluminum atoms or tetravalent silicon atoms in the ceramic catalyst support to tetravalent boron or tetravalent aluminum or pentavalent silicon, respectively, improves binding of the metal catalyst particles and provides bridging support to other components in catalyst layers, CCMs, and MEAs. Moreover, the use of ion exchange-functionalized catalyst supports increases the contacts between catalyst, electrode, and ionomer in catalyst layers, between catalyst layers and PEMs in CCMs, and between CCMs and gas diffusion layers (GDLs) and transport layers in MEAs, all of which increase the throughput, performance and stability of a CCM and MEA. The ion exchange-functionalized catalyst supports described herein have both ionomer properties (due to the surface ion exchange groups) as well as improved metal-binding properties, making the ion exchange-functionalized catalyst supports highly suitable for electrochemical applications. Accordingly, the ion exchange-functionalized catalyst supports may be used to support electrocatalyst particles in catalyst layers, CCMs, and/or MEAs, as well as to improve binding between different components (e.g., catalyst, ionomer, and membrane) in MEAs.

In some examples, the ion exchange-functionalized catalyst supports may be used in conjunction with (e.g., in addition to) carbon-based catalyst supports or other conventional catalyst supports in CCMs, making the CCMs durable over an increased number of cycles and enabling the CCMs to operate with much lower catalyst loading as well as reduced catalyst loss. For example, the ion exchange-functionalized catalyst supports may be bonded to or otherwise supported on carbon catalyst supports (e.g., graphite, graphene, carbon nanotubes, etc.). In other examples, the ceramic catalyst support of the ion exchange-functionalized catalyst supports may be a ceramic-carbon composite that includes a covalent ceramic material and electrically-conducting carbon (e.g., carbon fibers and powders including graphite, graphene, and carbon nanotubes). CCMs incorporating ion exchange-functionalized catalyst supports in conjunction with carbon catalyst supports have high potential for highly durable and effective alternatives to the convention carbon supports used in CCMs.

When the ceramic material of the ion exchange-functionalized catalyst supports is electrically conducting (e.g., an electrically conducting metal boride), the ion exchange-functionalized catalyst supports may replace the fragile carbon supports altogether. In such examples, the catalyst layer does not include a carbon support.

In some examples, an ion exchange-functionalized catalyst support may be an additive in a catalyst ink composition. For example, an ion exchange-functionalized catalyst support may be mixed with suitable compositions including ionomer, carbon (or other catalyst support), and catalyst particles. The ion exchange-functionalized catalyst support helps improve catalyst binding and helps form a better catalyst layer on a substrate (e.g., on a PEM or other membrane), thereby enhancing the throughput of decal transfer processes during transfer of the catalyst layer onto the substrate during manufacturing of MEAs. The use of ion exchange-functionalized catalyst supports as a component in catalyst ink for water electrolysis and fuel cell applications also provides efficient catalyst-ionomer-electrode binding, increased performance of CCMs and MEAs in water electrolysis and fuel cell systems, and improved catalyst turnover by decreasing catalyst loss. For example, ion exchange-functionalized catalyst supports enable enhanced binding of the components in CCMs and fine-tuning of the hydrophobic and hydrophilic balances in PEMs, catalyst layers, and CCMs, which greatly influences the performance of PEMs, catalyst layers, and CCMs in electrochemical cells. The improved catalyst binding improves catalyst performance and minimizes catalyst loss.

As mentioned, the ion exchange-functionalized catalyst supports described herein may be used in a catalyst layer and/or in a CCM, which may be included in a MEA for water electrolysis and fuel cell applications, among other applications. Illustrative catalyst layers, CCMs, and MEAs incorporating ion exchange-functionalized catalyst supports will now be described.

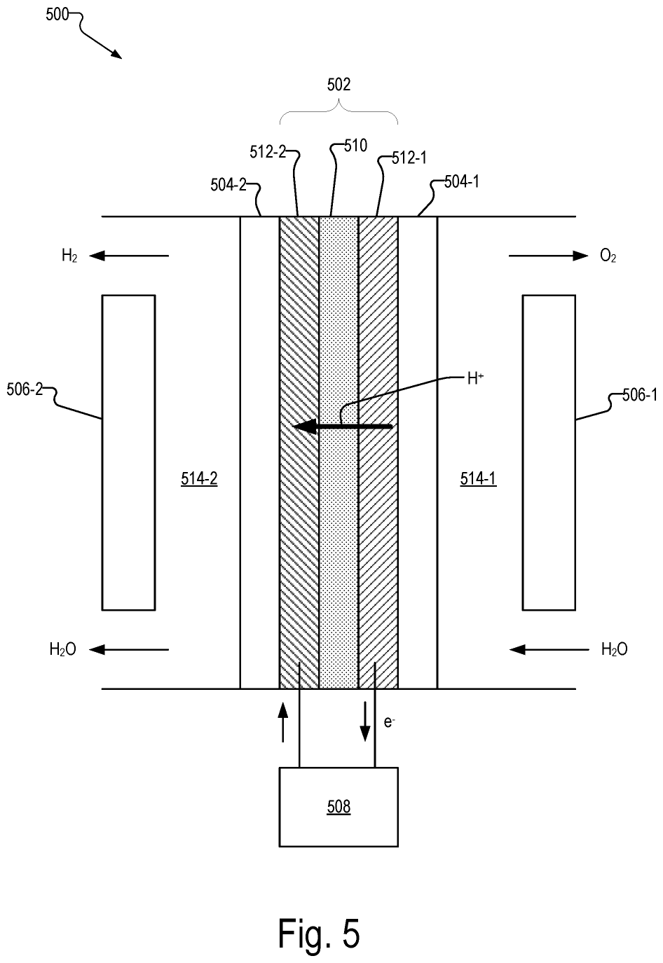

FIG. 5 shows an illustrative proton exchange membrane water electrolysis system 500 (PEM water electrolysis system 500). PEM water electrolysis system 500 uses electricity to split water into oxygen (O₂) and hydrogen (H₂) via an electrochemical reaction. The configuration of PEM water electrolysis system 500 is merely illustrative and not limiting, as other suitable configurations as well as other suitable water electrolysis systems may incorporate polyfluorinated linker-modified porous polymers.

As shown in FIG. 5, PEM water electrolysis system 500 includes a membrane electrode assembly 502 (MEA 502), porous transport layers 504-1 and 504-2, bipolar plates 506-1 and 506-2, and an electrical power supply 508. PEM water electrolysis system 500 may also include additional or alternative components not shown in FIG. 5 as may serve a particular implementation.

MEA 502 includes a PEM 510 positioned between a first catalyst layer 512-1 and a second catalyst layer 512-2. PEM 510 electrically isolates first catalyst layer 512-1 from second catalyst layer 512-2 while providing selective conductivity of cations, such as protons (H⁺), and while being impermeable to gases such as hydrogen and oxygen. PEM 510 may be implemented by any suitable organic or inorganic PEM. Illustrative examples of organic PEMs include, without limitation, synthetic polymers and natural polymers. Examples of synthetic polymers include sulfonic acid-functionalized polymers such as Nafion® (available from E.I. Dupont de Nemours and Company in various configurations and grades, including Nafion-H, Nafion HP Nafion 117, Nafion 115, Nafion 212, Nafion 211, Nafion NE1035, Nafion XL, etc.), Aquivion® (available from Solvay S.A. in different configurations and grades, including Aquivion® E98-05, Aquivion® PW98, Aquivion® PW87S, etc.), Gore-Select® (available from W.L. Gore & Associates, Inc.), Flemion™ (available from Asahi Glass Company), Pemion+™ (available from Ionomr Innovations, Inc.), and any combination, derivative, grade, or configuration thereof. Examples of natural polymers include, without limitation, lignin, cellulose, or chitin. Examples of inorganic PEMs include, without limitation, amorphous inorganic materials (e.g., glass, fused silica, or ceramics) and/or crystalline inorganic materials (e.g., quartz, single crystal silicon, or alumina). In some examples, the PEM includes a tetravalent boron.

First catalyst layer 512-1 and second catalyst layer 512-2 are electrically conductive electrodes with embedded electrochemical catalyst particles (not shown), such as platinum, ruthenium, and/or or cerium (IV) oxide, supported on an ion exchange-functionalized catalyst support. The ion exchange-functionalized catalyst support may be any one or more ion exchange-functionalized catalyst supports described herein. In some examples, first catalyst layer 512-1 and/or second catalyst layer 512-2 also includes a carbon catalyst support and/or an ionomer. An ionomer may be used to bind catalyst particles and increase conductivity of ions.

MEA 502 is placed between porous transport layers 504-1 and 504-2, which are in turn placed between bipolar plates 506-1 and 506-2 with flow channels 514-1 and 514-2 located in between bipolar plates 506 and porous transport layers 504.

In MEA 502, first catalyst layer 512-1 functions as an anode and second catalyst layer 512-2 functions as a cathode. When PEM water electrolysis system 500 is powered by power supply 508, an oxygen evolution reaction (OER) occurs at anode 512-1, represented by the following electrochemical half-reaction:

2H₂O→O₂+4H⁺+4e⁻

Protons are conducted from anode 512-1 to cathode 512-2 through PEM 510, and electrons are conducted from anode 512-1 to cathode 512-2 by conductive path around PEM 510. PEM 510 allows for the transport of protons (H⁺) and water from the anode 512-1 to the cathode 512-2 but is impermeable to oxygen and hydrogen. At cathode 512-2, the protons combine with the electrons in a hydrogen evolution reaction (HER), represented by the following electrochemical half-reaction:

4H⁺+4e⁻→2H₂

The OER and HER are two complementary electrochemical reactions for splitting water by electrolysis, represented by the following overall water electrolysis reaction:

2H₂O→2H₂+O₂

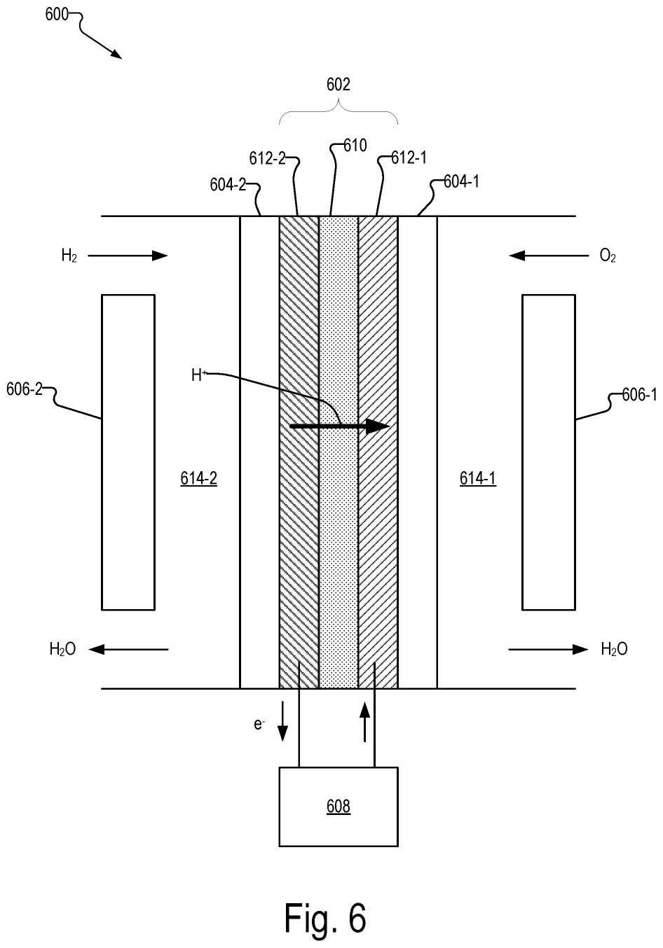

FIG. 6 shows an illustrative proton exchange membrane fuel cell 600 (PEM fuel cell 600) including polyfluorinated linker-modified polymers. PEM fuel cell 600 produces electricity as a result of electrochemical reactions. In this example, the electrochemical reactions involve reacting hydrogen gas (H₂) and oxygen gas (O₂) to produce water and electricity. The configuration of PEM fuel cell 600 is merely illustrative and not limiting, as other suitable configurations as well as other suitable PEM fuel cells may incorporate polyfluorinated linker-modified porous polymers.

As shown in FIG. 6, PEM fuel cell 600 includes a membrane electrode assembly 602 (MEA 602), porous transport layers 604-1 and 604-2, bipolar plates 606-1 and 606-2. An electrical load 608 may be electrically connected to MEA 602 and driven by PEM fuel cell 600. PEM fuel cell 600 may also include additional or alternative components not shown in FIG. 6 as may serve a particular implementation.

MEA 602 includes a PEM 610 positioned between a first catalyst layer 612-1 and a second catalyst layer 612-2. PEM 610 electrically isolates first catalyst layer 612-1 from second catalyst layer 612-2 while providing selective conductivity of cations, such as protons (H⁺), and while being impermeable to gases such as hydrogen and oxygen. PEM 610 may be implemented by any suitable PEM, including any PEM described herein (e.g., PEM 510).

First catalyst layer 612-1 and second catalyst layer 612-2 are electrically conductive electrodes with embedded electrochemical catalysts (not shown), supported on an ion exchange-functionalized catalyst support. The ion exchange-functionalized catalyst support may be any one or more ion exchange-functionalized catalyst supports described herein. In some examples, first catalyst layer 612-1 and/or second catalyst layer 612-2 also includes a carbon catalyst support and/or an ionomer. An ionomer may be used to bind catalyst particles and increase conductivity of ions.

MEA 602 is placed between porous transport layers 604-1 and 604-2, which are in turn placed between bipolar plates 606-1 and 606-2 with flow channels 614-1 and 614-2 located in between. In MEA 602, first catalyst layer 612-1 functions as a cathode and second catalyst layer 612-2 functions as an anode. Cathode 612-1 and anode 612-2 are electrically connected to load 608, and electricity generated by PEM fuel cell 600 drives load 608.

During operation of PEM fuel cell 600, hydrogen gas (H₂) flows into the anode side of PEM fuel cell 600 and oxygen gas (O₂) flows into the cathode side of PEM fuel cell 600. At anode 612-2, hydrogen molecules are catalytically split into protons (H⁺) and electrons (e⁻) according to the following hydrogen oxidation reaction (HOR):

2H₂→4H⁺+4e⁻

The protons are conducted from anode 612-2 to cathode 612-1 through PEM 600, and the electrons are conducted from anode 612-2 to cathode 612-1 around PEM 610 through a conductive path and load 608. At cathode 612-1, the protons and electrons combine with the oxygen gas according to the following oxygen reduction reaction (ORR):

O₂+4H⁺+4e⁻→2H₂O

Thus, the overall electrochemical reaction for the PEM fuel cell 600 is:

2H₂+O₂→2H₂O

In the overall reaction, PEM fuel cell 600 produces water at cathode 612-1. Water may flow from cathode 612-1 to anode 612-2 through PEM 610 and may be removed through outlets at the cathode side and/or anode side of PEM fuel cell 600. The overall reaction generates electrons at the anode that drive load 608.

In some examples, one or more of the ionomers, membranes, and PEMs of system 500 or system 600 may be implemented by an ionomer, membrane, and/or PEM described in International Patent Application No. PCT/US2021/029705, filed Apr. 28, 2021; International Patent Application No. PCT/US2021/038956, filed Jun. 24, 2021; International Patent Application No. PCT/US2022/039845, filed Aug. 9, 2022; International Patent Application No. PCT/US2022/043878, filed Sep. 16, 2022, U.S. Provisional Patent Application No. 63/302,755, filed Jan. 25, 2022; and U.S. Provisional Patent Application No. 63/324,471, filed Mar. 28, 2022, each of which is incorporated herein in its entirety.

The ion exchange-functionalized catalyst supports described herein may also be used in applications other than fuel cell and water electrolysis. For example, the ion exchange-functionalized catalyst supports may be used for other electrochemical reactions, such as in ammonia production using nitrogen and hydrogen and methanol production using electrochemical reduction of carbon dioxide (CO₂).

In the preceding description, various exemplary embodiments and examples have been described. It will, however, be evident that various modifications and changes may be made thereto, and additional embodiments and examples may be implemented, without departing from the scope of the claims that follow. For example, certain features of one embodiment or example described herein may be combined with or substituted for features of another embodiment or example described herein. The description and drawings are accordingly to be regarded in an illustrative rather than a restrictive sense.

Advantages and features of the present disclosure can be further described by the following examples:

Example 1. An ion exchange-functionalized catalyst support comprising: a ceramic catalyst support comprising a covalent nitride, a covalent metal boride, or a covalent carbide; and an ion exchange group at a surface of the ceramic catalyst support.

Example 2. The ion exchange-functionalized catalyst support of example 1, wherein the ceramic catalyst support comprises a binary nitride comprising boron, silicon, or aluminum.

Example 3. The ion exchange-functionalized catalyst support of example 2, wherein the binary nitride comprises boron nitride, silicon nitride, and aluminum nitride.

Example 4. The ion exchange-functionalized catalyst support of example 2, wherein the ion exchange group includes a boron atom, a silicon atom, or an aluminum atom of the covalent nitride.

Example 5. The ion exchange-functionalized catalyst support of example 4, wherein the boron atom, the silicon atom, or the aluminum atom of the ion exchange group has a negative formal charge.

Example 6. The ion exchange-functionalized catalyst support of example 2, wherein the binary nitride comprises hexagonal boron nitride.

Example 7. The ion exchange-functionalized catalyst support of example 1, wherein: the ceramic catalyst support comprises a ternary nitride comprising two of boron, silicon, and carbon.

Example 8. The ion exchange-functionalized catalyst support of example 7, wherein the ternary nitride further comprises carbon.

Example 9. The ion exchange-functionalized catalyst support of example 7, wherein the ternary nitride comprises a boron carbon nitride, a silicon carbon nitride, or a silicon boron nitride.

Example 10. The ion exchange-functionalized catalyst support of example 7, wherein the ion exchange group comprises a boron atom or a silicon atom of the ternary nitride.

Example 11. The ion exchange-functionalized catalyst support of example 10, wherein the boron atom or the silicon atom of the ion exchange group has a negative formal charge.

Example 12. The ion exchange-functionalized catalyst support of example 1, wherein: the ceramic catalyst support comprises the metal boride; and the ion exchange group includes a boron atom of the metal boride.

Example 13. The ion exchange-functionalized catalyst support of example 12, wherein the boron atom of the ion exchange group has a negative formal charge.

Example 14. The ion exchange-functionalized catalyst support of example 12, wherein the metal boride comprises titanium, zirconium, or hafnium.

Example 15. The ion exchange-functionalized catalyst support of example 12, wherein the metal boride comprises vanadium, niobium, or tantalum.

Example 16. The ion exchange-functionalized catalyst support of example 12, wherein the metal boride is electrically conducting.

Example 17. The ion exchange-functionalized catalyst support of any of examples 1-16, wherein the ion exchange group comprises a tetravalent boron atom, a tetravalent aluminum atom, or a pentavalent silicon atom.

Example 18. The ion exchange-functionalized catalyst support of any of examples 1-17, wherein the ion exchange group comprises an acid ester.

Example 19. The ion exchange-functionalized catalyst support of any of examples 1-17, wherein the ion exchange group comprises fluorine.

Example 20. The ion exchange-functionalized catalyst support of any of examples 1-19, further comprising a carbon support, wherein the ceramic catalyst support is bonded to the carbon support.

Example 21. The ion exchange-functionalized catalyst support of any of examples 1-20, wherein the ceramic catalyst support comprises a composite material.

Example 22. The ion exchange-functionalized catalyst support of example 21, wherein the composite material comprises the covalent nitride and the covalent carbide.

Example 23. The ion exchange-functionalized catalyst support of example 22, wherein the composite material comprises a boron nitride-boron carbide composite, a boron nitride-silicon carbide composite, a silicon nitride-silicon carbide composite, or a silicon nitride-boron carbide composite.

Example 24. The ion exchange-functionalized catalyst support of example 21, wherein the composite material comprises a ternary nitride and at least one of a boron carbide or a silicon carbide.

Example 25. A catalyst layer comprising: an ion exchange-functionalized catalyst support comprising: a ceramic catalyst support comprising a covalent nitride, a covalent metal boride, or a covalent carbide; and an ion exchange group at a surface of the ceramic catalyst support; and a catalyst particle supported on the ion exchange-functionalized catalyst support.

Example 26. The catalyst layer of example 25, further comprising a carbon support, wherein the ion exchange-functionalized catalyst support is bonded to the carbon support.

Example 27. The catalyst layer of example 25 or 26, further comprising an ionomer.

Example 28. The catalyst layer of example 27, wherein the ionomer comprises a tetravalent boron-based acid group.

Example 29. The catalyst layer of any of examples 25-28, wherein the ceramic catalyst support is electrically conducting.

Example 30. The catalyst layer of example 29, wherein the catalyst layer does not include a carbon support.

Example 31. The catalyst layer of any of examples 25-30, wherein the catalyst particle comprises a platinum group metal, a transition metal, a metal alloy, or a metal oxide.

Example 32. The catalyst layer of any of examples 25-31, wherein: the ceramic catalyst support comprises the covalent nitride; the covalent nitride comprises boron, silicon, or aluminum; and the ion exchange group includes a boron atom, a silicon atom, or an aluminum atom of the covalent nitride.

Example 33. The catalyst layer of example 32, wherein the boron atom, the silicon atom, or the aluminum atom of the ion exchange group has a negative formal charge.

Example 34. The catalyst layer of example 33, further comprising a cation ionically linked to the boron atom, the silicon atom, or the aluminum atom of the ion exchange group.

Example 35. The catalyst layer of example 34, wherein the cation comprises a proton, a metal cation, or tetraalkylammonium.

Example 36. The catalyst layer of any of examples 25-35, wherein: the ceramic catalyst support comprises the metal boride; and the ion exchange group includes a boron atom of the metal boride.

Example 37. The catalyst layer of example 36, wherein the boron atom of the ion exchange group has a negative formal charge.

Example 38. The catalyst layer of example 37, further comprising a cation ionically linked to the boron atom of the ion exchange group.

Example 39. The catalyst layer of example 38, wherein the cation comprises a proton, a metal cation, or tetraalkylammonium.

Example 40. The catalyst layer of any of examples 25-39, wherein the ion exchange group comprises fluorine.

Example 41. The catalyst layer of any of examples 25-39, wherein the ion exchange group comprises an acid ester.

Example 42. A method of making an ion exchange-functionalized catalyst support, comprising: functionalizing a surface of a ceramic catalyst support with an ion exchange group, the ceramic catalyst support comprising a covalent nitride, a covalent metal boride, or a covalent carbide.

Example 43. The method of example 42, wherein: the ceramic catalyst support comprises boron, silicon, or aluminum; and the functionalizing comprises covalently bonding a nucleophilic reagent with a boron atom, a silicon atom, or an aluminum atom of the ceramic catalyst support at the surface of the ceramic catalyst support.

Example 44. The method of example 43, wherein the nucleophilic reagent comprises hydrogen fluoride, a metal fluoride, or a tetraalkylammonium fluoride.

Example 45. The method of example 43, wherein the nucleophilic reagent comprises an acid, a salt of an acid, a partial ester of a polybasic acid, or an alcohol.

1. An ion exchange-functionalized catalyst support comprising:
a ceramic catalyst support comprising a covalent nitride, a covalent metal boride, or a covalent carbide; and
an ion exchange group at a surface of the ceramic catalyst support.

2. The ion exchange-functionalized catalyst support of claim 1, wherein the ceramic catalyst support comprises the covalent nitride, the covalent nitride comprising a binary nitride, the binary nitride comprising boron nitride, silicon nitride, or aluminum nitride.

3. (canceled)

4. The ion exchange-functionalized catalyst support of claim 2, wherein:
the ion exchange group includes a boron atom, a silicon atom, or an aluminum atom of the binary nitride; and
the boron atom, the silicon atom, or the aluminum atom of the ion exchange group has a negative formal charge.

5. The ion exchange-functionalized catalyst support of claim 2, wherein the binary nitride comprises hexagonal boron nitride.

6. The ion exchange-functionalized catalyst support of claim 1, wherein the ceramic catalyst support comprises the covalent nitride, the covalent nitride comprising a ternary nitride, the ternary nitride comprising a boron carbon nitride, a silicon carbon nitride, or a silicon boron nitride.

7. (canceled)

8. The ion exchange-functionalized catalyst support of claim 6, wherein:
the ion exchange group comprises a boron atom or a silicon atom of the ternary nitride; and
the boron atom or the silicon atom of the ion exchange group has a negative formal charge.

9. The ion exchange-functionalized catalyst support of claim 1, wherein:
the ceramic catalyst support comprises the covalent metal boride;
the ion exchange group includes a boron atom of the covalent metal boride; and
the boron atom of the ion exchange group has a negative formal charge.

10. The ion exchange-functionalized catalyst support of claim 9, wherein the covalent metal boride comprises titanium, zirconium, hafnium, vanadium, niobium, or tantalum.

11-12. (canceled)

13. The ion exchange-functionalized catalyst support of claim 1, wherein the ion exchange group comprises a tetravalent boron atom, a tetravalent aluminum atom, or a pentavalent silicon atom.

14. The ion exchange-functionalized catalyst support of claim 1, wherein the ion exchange group comprises fluorine.

15-16. (canceled)

17. A catalyst layer comprising:
an ion exchange-functionalized catalyst support comprising:
a ceramic catalyst support comprising a covalent nitride, a covalent metal boride, or a covalent carbide; and
an ion exchange group at a surface of the ceramic catalyst support; and
a catalyst particle supported on the ion exchange-functionalized catalyst support.

18. (canceled)

19. The catalyst layer of claim 17, further comprising an ionomer.

20. The catalyst layer of claim 17, wherein the ceramic catalyst support is electrically conducting and the catalyst layer does not include a carbon catalyst support.

21. (canceled)

22. The catalyst layer of claim 17, wherein:
the ceramic catalyst support comprises the covalent nitride;
the covalent nitride comprises boron, silicon, or aluminum;
the ion exchange group includes a boron atom, a silicon atom, or an aluminum atom of the covalent nitride; and
the boron atom, the silicon atom, or the aluminum atom of the ion exchange group has a negative formal charge.

23. The catalyst layer of claim 17, wherein:
the ceramic catalyst support comprises the covalent metal boride;
the ion exchange group includes a boron atom of the covalent metal boride; and
the boron atom of the ion exchange group has a negative formal charge.

24. The catalyst layer of claim 22, further comprising a cation ionically linked to the ion exchange group, wherein the cation comprises a proton, a metal cation, or tetraalkylammonium.

25-26. (canceled)

27. A method of making an ion exchange-functionalized catalyst support, comprising:
functionalizing a surface of a ceramic catalyst support with an ion exchange group, the ceramic catalyst support comprising a covalent nitride, a covalent metal boride, or a covalent carbide.

28. The method of claim 27, wherein:
the ceramic catalyst support comprises boron, silicon, or aluminum; and
the functionalizing comprises covalently bonding a nucleophilic reagent with a boron atom, a silicon atom, or an aluminum atom of the ceramic catalyst support at the surface of the ceramic catalyst support.

29. The method of claim 28, wherein the nucleophilic reagent comprises hydrogen fluoride, a metal fluoride, or a tetraalkylammonium fluoride.

30. The method of claim 28, wherein the nucleophilic reagent comprises an acid, a salt of an acid, a partial ester of a polybasic acid, or an alcohol.
